(19) United States
(12) Patent Application Publication
(10) Pub. No.: US 2007/0050094 A1
(43) Pub. Date: Mar. 1, 2007

(54) ELECTRIC VACUUM CLEANER

(75) Inventors: HIROYUKI KUSHIDA, Kanagawa (JP); Akihiro Ishizawa, Kanagawa (JP); Susumu Hoshino, Kanagawa (JP)

Correspondence Address: DLA PIPER US LLP, P. O. BOX 9271, RESTON, VA, 20195, US

(73) Assignee: TOSHIBA TEC KABUSHIKI KAISHA, SHINAGAWA-KU (JP)

(21) Appl. No.: 11/467,939

(22) Filed: Aug. 29, 2006

(30) Foreign Application Priority Data
Aug. 30, 2005 (JP) 2005-250390

(51) Int. Cl. G05D 11/00; H01H 43/00; A47L 5/00

(52) U.S. Cl. 700/298; 15/319; 700/286; 700/291; 700/306

(57) ABSTRACT

An electric vacuum cleaner comprises an electric blower having a commutator motor connected to an alternate current power source though a switching element, a current detecting section detecting a load current flowing in the electric blower, a control section generating a control signal that controls the input power to the vacuum cleaner by adjusting a trigger time of the switching element, wherein a current detecting circuit sends a signal having a periodic waveform derived from the alternate current source to the control section. The control section sets an operation mode to a preparation mode or a cleaning mode. Initially, in the preparation mode a correction value of the load current is acquired with the trigger time set at a predetermined point. In the cleaning mode, the input power is controlled by varying the trigger time of the control signal according to a difference between a load current detected by the current detecting section and the correction value acquired in the preparation mode.

### CROSS REFERENCE OF THE INVENTION

This application is based upon and claims the benefit of priority from the prior Japanese Patent Application No. 2005-250390 filed on Aug. 30, 2005, the contents of which are incorporated herein by reference.

### BACKGROUND OF THE INVENTION

1. Field of the Invention

The present invention relates to an electric cleaner comprising an electric blower having a commutator motor operating on an alternate-current power.

2. Description of the Related Art

A conventional electric vacuum cleaner typically controls its input power by detecting a load current that flows in an electric blower and comparing the load current with a preset reference value. As a result, the electric vacuum cleaner maintains a desired suction power regardless of increase of an airflow resistance according to accumulation of collected dust in its dust collecting section. However, because of errors of detected load current resulted from variation of parts used in the current detection circuit, input powers in plural electric vacuum cleaners vary from one to another even though they all use the same control circuit. Therefore, such variations of the input power in individual products of such an electric vacuum cleaner need be compensated before shipment from a factory.

There is a known method of compensating such a variation of the input power, as described, for example, in Japanese Laid-open Patent Application No. 9-122052. The conventional vacuum cleaner described in the above publication operates as follows. A current detection circuit 22 amplifies, rectifies, and smoothes a current detected by a current detecting means 21. A microcomputer 13 controls the input power to the electric blower so that the output of current detection circuit 22 conforms to an objective current value. A transmission operating means 30 compares the input power to the electric blower with the objective input power when the output of current detection circuit 22 has conformed to the objective current value, generates and outputs an adjusting signal. A main body 1 of the electric vacuum cleaner corrects the objective current value according to the adjusting signal. Microcomputer 13 then controls the input power into the electric blower so that the output of current detection circuit 22 conforms to the corrected objective current value. These operations are reiterated until the input power to the electric blower conforms to the objective input value. This method is advantageous in respect that there is no need of manually compensating variations of the input power by adjusting a variable resistor on a circuit board.

Generally, an electric vacuum cleaner uses a commutator motor as a blower motor operating on an alternate-current power. The current flowing in a commutator contains a fair amount of a ripple component that is produced by a sliding action between a commutator and brushes of the motor. Accordingly, in view of compensating errors resulted from variation of parts that constitute the load current detecting circuit or others within the device, this ripple component should be taken into consideration.

In the electric vacuum cleaner described in the above publication, because the output of current detection circuit 22 is provided as being smoothed and microcomputer 13 controls the error correction based on this output, the accuracy of detecting the ripple component is not sufficient. Accordingly, the input power control for the electric blower based on its load current could not accurately been achieved.

### SUMMARY OF THE INVENTION

An object of the present invention is, therefore, to provide an electric vacuum cleaner that improves an accuracy of controlling an input power into its electric blower according to a load current of a commutator motor.

To accomplish the above object, the present invention provides an electric vacuum cleaner, which comprises:
an electric blower having a commutator motor connected to an alternate-current power source through a switching element controlled by a control signal and a fan rotated by the commutator motor;
a zero-cross detecting section for detecting a zero crossover point of an alternate-current voltage applied to the commutator motor;
a current detecting section for detecting a load current flowing in the commutator motor;
a control section for controlling a timing of outputting the control signal relative to the zero crossover point detected by the zero-cross detecting section based on a value of the load current detected by the current detecting section and a preset current reference value;
a current detecting circuit for generating a signal having a periodic waveform using the load current detected by said current detecting section and outputting the periodic signal to said control section, the periodic signal generated by said current detecting circuit relating to the alternate-current voltage,

wherein said control section comprising:
operation mode setting means for setting an operation mode of the vacuum cleaner to one of a preparation mode in which the output timing of the control signal is fixed and a cleaning mode in which the output timing of the control signal is set variable; load current momentary value acquiring means for acquiring load current momentary values by sampling the output from said current detecting circuit in a specified sampling interval, the sampling commencing based on the zero crossover point detected by the zero-cross detecting section;
storing means for storing a correction value that is determined based on the load current momentary values acquired by said load current momentary value acquiring means in the preparation mode;
timing determining means for determining the timing of outputting the control signal to the switching element in the cleaning mode based on the load current momentary values acquired by said load current momentary value acquiring means, the current reference value, and the correction value.

### BRIEF DESCRIPTION OF THE DRAWINGS

FIG. 1 is a perspective view of a structure of an electric vacuum cleaner according to an embodiment of the present invention.

FIG. 2 is a diagram illustrating a circuitry structure of a controller in an electric vacuum cleaner according to the first embodiment of the present invention.

FIG. 3 illustrates waveforms of voltages, currents, and signals in the respective sections according to the first embodiment of the present invention.

FIG. 4 is a functional block diagram of a control section according to the first embodiment of the present invention.

FIG. 5 shows a table of instructive delay times, lower limits and upper limits of a load current used in the first embodiment according to the present invention.

FIG. 6 is a graph illustrating a relation between a sucking air volume of an electric blower and a load current compensation value when an electric vacuum cleaner according to the first embodiment of the present invention is operated, wherein an instructive delay time, a lower limit and upper limit of a load current are taken as parameters.

FIG. 7 is a flowchart illustrating a main flow of the processing operated by the control section according to the first embodiment of the present invention.

FIG. 8 is a flowchart illustrating processing for computing a load current error operated in the preparation mode by the control section according to the first embodiment of the present invention.

FIG. 9 is a flowchart illustrating processing on zero-crossing operated in the preparation mode by the control section according to the first embodiment of the present invention.

FIG. 10 is a flowchart illustrating processing for load current computing error correction operated in the cleaning mode by the control section according to the first embodiment of the present invention.

FIG. 11 is a flowchart illustrating processing on zero-crossing operated in the cleaning mode by the control section according to the first embodiment of the present invention.

FIG. 12 is a flowchart illustrating processing for outputting a control signal operated by the control section according to the first embodiment of the present invention.

FIG. 13 is a functional block diagram according to the second embodiment of the present invention.

FIG. 14 is a flowchart illustrating processing on zero-crossing operated in the preparation mode by the control section according to the third embodiment of the present invention.

### DETAILED DESCRIPTION OF THE INVENTION

### First Embodiment

Hereinafter, some embodiments according to the present invention will be described in conjunction with accompanying drawings.

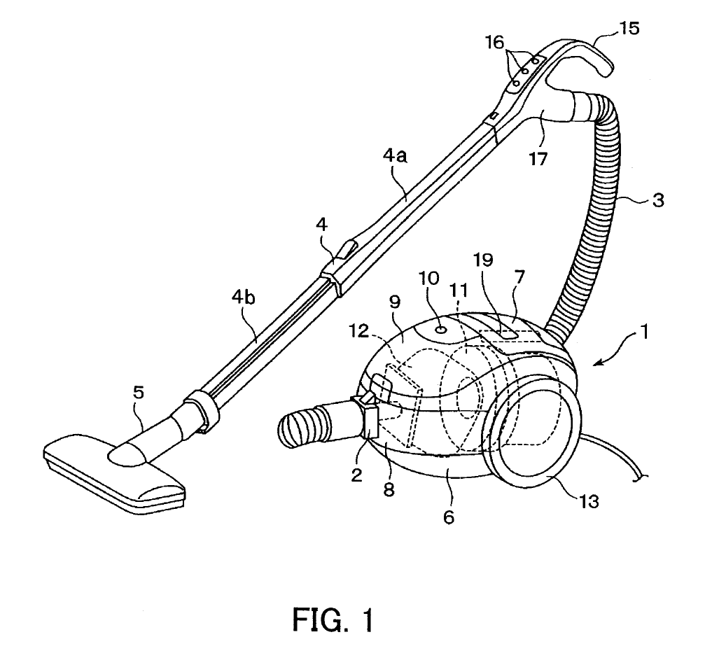

A structure of the electric vacuum cleaner will be explained in reference to FIG. 1. The electric vacuum cleaner comprises a main body 1 of the electric vacuum cleaner (hereinafter, referred to as merely “main body”), a hose 3 that is detachably connected at its one end to an suction inlet 2 provided in main body 1, an extension pipe 4 whose one end is detachably connected to the other end of hose 3, and a suction inlet body 5 whose one end is detachably connected to the other end of extension pipe 4.

Main body 1 comprises a lower case 6 whose upper end is open, an upper case 7 that closes a rear top of lower case 6. In the peripheral border of main body 1, there is provided a bumper 8, which is held by lower case 6 and upper case 7. In main body 1, a lid 9 for closing an opening of the upper front of lower case 6 is provided as it freely opens and closes the opening. On this lid 9, an annunciating section 10 is provided which annunciates to the operator a state of being filled-up with dust within a dust-collecting bag of the electric vacuum cleaner. This annunciating section 10 is constituted by a light emitting device such as a LED, sounding device, etc. Within main body 1 a dust-collecting bag 12 is provided, which is in fluid communication with electric blower 11. Dust-collecting bag 12 constitutes a dust-collecting part, and is in fluid communication with hose 3 through main body inlet 2. It is configured that, by letting sucked air of electric blower 11 through dust-collecting bag 12, dust in the sucked air is separated from the air and collected within dust-collecting bag 12. A freely swivable wheels 13 (not shown) is provided in the lower front of main body 1, and a pair of rear wheels 13 (only one of the two shown) are provided on rear sides.

Hose 3 is made of a retractable, bendable material in a cylindrical form and provided with a manual operating section 17. Manual operating section 17 has a handle 15 and operating buttons 16 which set the condition of air ntake to electric blower 11. Extension pipe 4 consists of a large-diameter pipe 4a and a small-diameter pipe 4b that is inserted into the large-diameter pipe 4a. A total length of extension pipe 4 can be continuously adjusted by sliding small-diameter pipe 4b in or out within large-diameter pipe 4a. Suction inlet body 5 is provided with a suction opening (not shown) from which dusts on a surface of an object to be cleaned is sucked in, and is detachably fitted with this extension pipe 4 at its leading edge of the pipe. Within main body 1, a circuit board 19 including a control section 18 is incorporated.

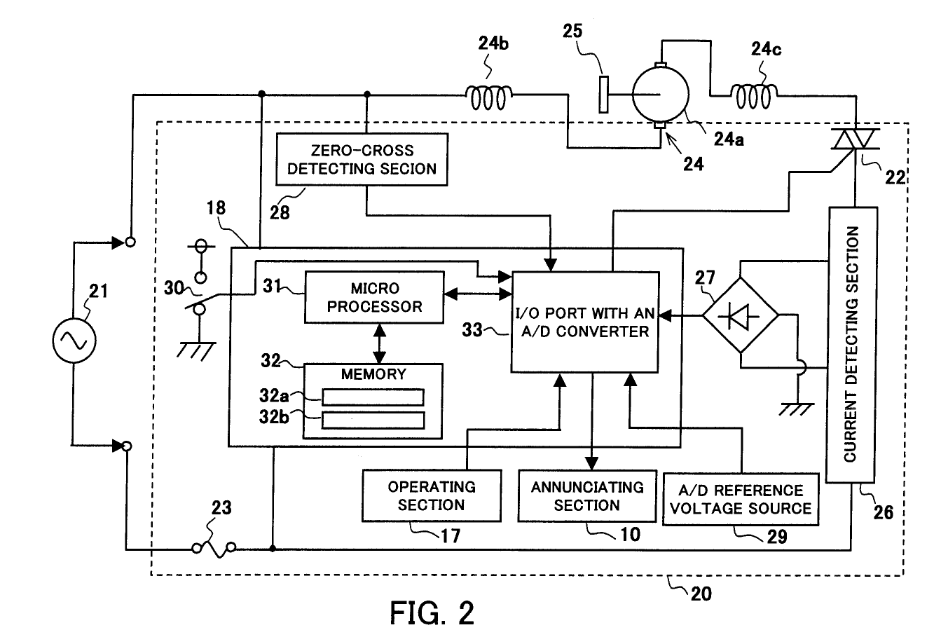

Now, a controller 20 of the electric vacuum cleaner that includes control section 18 will be described in reference to FIG. 2. Reference numeral 21 denotes a commercial AC power source, to which a switching element, e.g. bi-directional three-terminal thyristor 22 (hereinafter referred to as merely “three-terminal thyristor”) that is controlled by a control signal, a current fuse 23, and a commutator motor 24 (hereinafter referred to as merely “motor”) are connected in series.

Electric blower 11 has a motor 24 and a fan 25 rotated by this motor 24. Motor 24 is a universal type typically comprising, for example, brushes (not shown) and an armature 24a having a commutator that is rubbed with the brushes, and field coils 24b and 24c. Fan 25 is of a centrifugal type, which is fixed to the rotating shaft of motor 24. Dust-containing air is sucked into main body 1 from suction inlet body 5 via extension pipe 4 and hose 3.

Reference numeral 26 denotes a current detecting section, which typically comprises a current transformer or a hall element and detects a load current flowing in motor 24. The load current detected by current detection section 26 is rectified in a rectifying section 27 as a current detection circuit, converted into a voltage, and inputted to an I/O port (described later) within control section 18. Rectifying section 27 can be constituted, for example, by a full-wave rectifier circuit consisting of four diodes in bridge connection or a half-wave rectifier circuit having one diode. Because a voltage inputted to the I/O port is not smoothed by smoothing capacitor(s) or the like, it appears to be a periodic waveform derived from an alternate-current voltage. Reference numeral 28 denotes a zero-cross detecting section, which detects a zero-cross point in the alternate-current power voltage applied to motor 24.

Connected to I/O port in control section 18 are an A/D reference voltage source 29, manual operating section 17, and annunciating section 10. The I/O port receives an A/D reference voltage from A/D reference voltage source 29, instructing signals from hand-operation section. The instructing signals are outputted to annunciating section 10. Reference numeral 30 denotes an operation mode switch provided in circuit board 19, which switches an operation mode in control section 18 from the preparation mode to the cleaner operating mode or vice versa, which will be described later.

Control section 18 acquires a load current, zero-cross timing, A/D reference voltage, operation mode setting signal, and instruction signals. It feeds a control signal that serves as a trigger signal to a gate of a three-terminal thyristor 22.

Control section 18 is comprised of a microprocessor 31, memory 32, I/O port 33 having an A/D converting function as mentioned above. Memory 32b is a non-volatile memory region, in which control programs that microprocessor 31 executes and data such as necessary constants are previously stored. Memory 32a is used as the data storage area wherein data in the non-volatile memory region 32b and computing data used by microprocessor 31 are temporally stored.

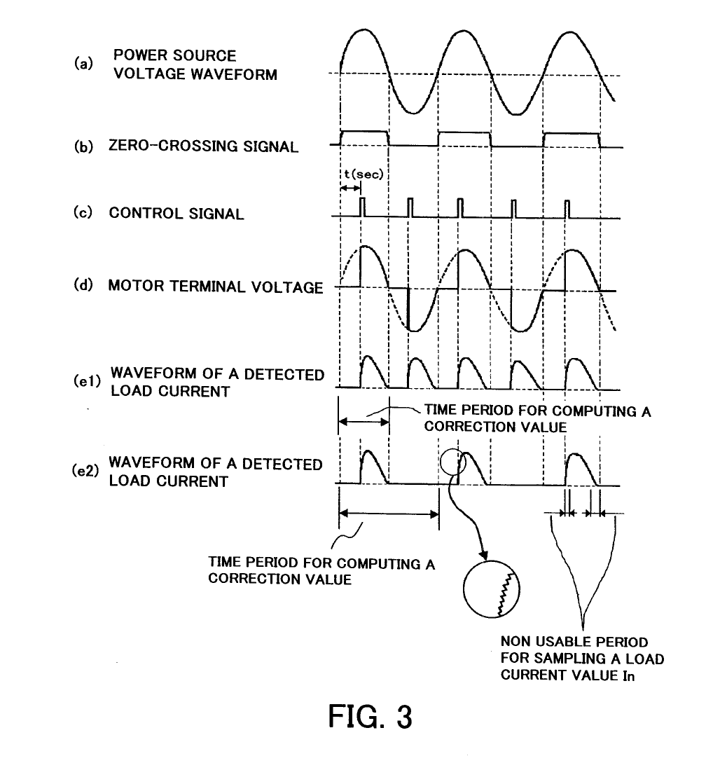

FIG. 3(a) depicts a waveform of a voltage available in commercial alternate-current power source 21. When a control signal is fed from control section 18 to a gate of three-terminal thyristor 22 at the timing indicated in FIG. 3(c), three-terminal thyristor 22 becomes conducted therefrom until the power voltage reverses its phase. Consequently, a voltage as depicted in FIG. 3(d) is imparted between the terminals of electric blower 11.

When the power voltage reverses, a zero-cross signal indicated in FIG. 3(b) is fed from zero-cross detecting section 28 to I/O port 33 in control section 18. Assuming a period of the alternate-current voltage as Tv (second), an interval from a zero-crossover point in this alternate-current voltage to a starting point of the control signal as t (second), a conduction angle Φ(%) of three-terminal thyristor 22 is given by a formula of
Φ={(Tv/2)−t}/(Tv/2)×100
Hereinafter, an interval t (second) from the zero-crossover point in the alternate-current voltage to a starting point of the control signal will be referred to as a “delay time.”

Where a full-wave rectifier circuit is employed in rectifying section 27, a waveform of a load current inputted to I/O port 33 appears, for example, as shown in FIG. 3(e1). If a half-wave rectifier circuit is employed in rectifying section 27, a waveform of the load current inputted to I/O port 33 appears, for example, as shown in FIG. 3(e2). As can be seen in the FIGURES, a waveform of the load current inputted to I/O port 33 reflects a ripple component created in motor 24 because the current is not smoothed by electrolytic capacitor(s) or other components.

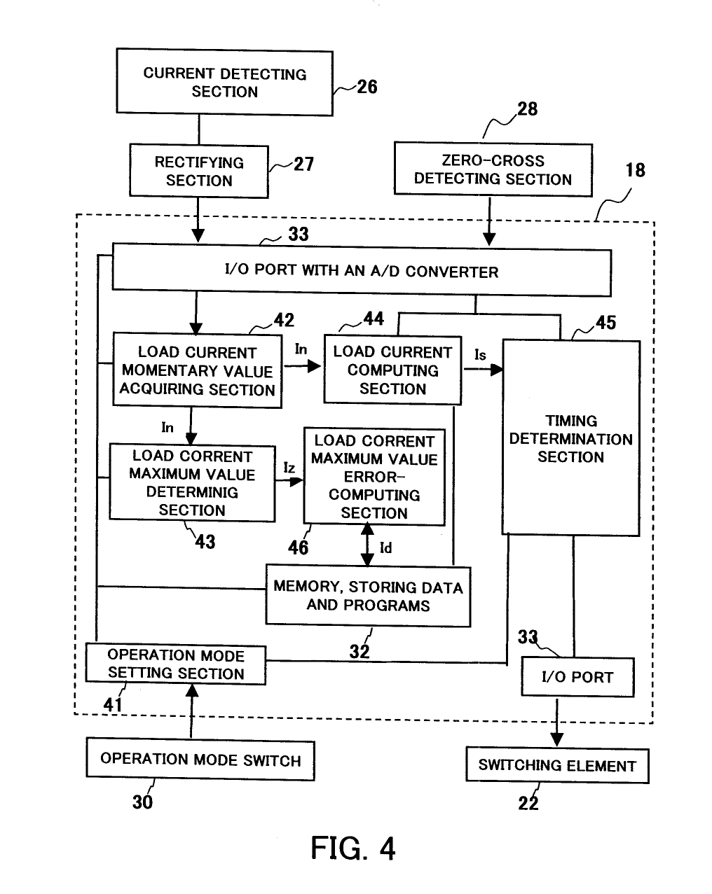

The functions of the respective parts in control section 18 will now be described in reference to FIG. 4. A microprocessor within control section 18 is comprised of, mainly, an operation mode setting section 41, load current momentary value acquiring section 42, load current maximum value determining section 43, load current computing section 44, timing determining section 45 and load current maximum value error-computing section 46. Recognizing a voltage signal generated associated with a switching action of operation mode switch 30, operation mode setting section 41 in control section 18 sets the operation mode to the preparation mode or cleaning mode. The cleaning mode is an operation mode of control section 18 normally used by an operator, in which the input power to the electric blower 11 is varied based on a current value detected by current detection section 26. The preparation mode, which is a non-operator relevant mode, is provided to compensate errors resulted depending on circuit parts in individual vacuum cleaners while an input power into a cleaner is fixed to a predetermined level. The respective operation modes will be described below.

First, the preparation mode will be described. This mode is operated prior to the shipment of the vacuum cleaners. First, for a reference load whose electrical characteristics is previously known, for example, a standard electric blower, resistive load, or electronic load is prepared and connected to vacuum cleaner controller 20. The electric blower is operated with a predetermined power input, which is set by generating a control signal having a specified delay time relative to a zero-crossover point determined by timing determining section 45. That is, the electric blower is operated with the control signal outputted at a fixed output timing. In this state, load current momentary value acquiring section 42 acquires load current momentary values In from current detection section 26, sampling the load current in a preset sampling interval in time reference to a zero-crossover point in an alternate-current power voltage detected by zero-cross detection section 28. These load current momentary values In are then inputted to load current maximum value determining section 43. This load current maximum value determining section 43 individually compares the acquired load current momentary values (I1, I2 . . . , In) that have been sampled at a specified number of times, and determines a load current maximum value Iz among them.

Then, load current maximum value determining section 43 outputs this determined load current maximum value Iz to a load current maximum value error-computing section 46. Load current maximum value error-computing section 46 compares this determined load current maximum value Iz with a pre-specified load current maximum reference value Ip (an ideal value determined assuming no variations), and a resulted difference between the two values is determined to be a load current correcting value Id as a corrective error. This load current correcting value Id is stored at non-volatile memory 8b. The load current correcting value Id is obtained using a data table or a formula based on a difference between load current maximum value Iz and load current maximum reference value Ip. A computing period of load current maximum value Iz is, for example, a half cycle in the alternate-current power voltage shown in FIG. 3(e1), and a full cycle of it shown in FIG. 3(e2). The operation in this preparation mode is sometimes carried out before the circuit board 19 is incorporated into main body 1.

Next, the cleaning mode will be described. This mode is activated when an operator actually performs cleaning work using the electric vacuum cleaner. In this mode, when an operator operates an appropriate operating button 16 in the manual operating section 17 and so the electric blower starts to operate, load current momentary value acquiring section 42 acquires load current momentary values In from current detecting section 26 in a specified sampling interval, and outputs load current momentary value In to load current computing section 44.

Load current computing section 44 then operates in one of the following two manners: first operation type and the second operation type. In the first operation type, load current computing section 44 computes a load current momentary correction value from the load current momentary values In and the load current correction value Id stored in the preparation mode, further computing a load current computing correction value Is by adding the computed current load momentary correction value specified sampling times, and outputs this load current computing correction value Is to timing determining section 45. The load current momentary correction value can be computed, for example, by adding or subtracting the load current correction value Id to/from load current momentary value In.

In the second operation type, load current computing section 44 computes a load current computing value IsO by adding a load current momentary value In specified sampling times, further computing a load current computing correction value Is from the load current computing value IsO and the load current correction value Id, and outputs this load current computing correction value Is to timing determining section 45. The load current computing correction value Is can be computed, for example, by adding or subtracting the load current correction value Id to/from a load current computing value IsO.

Timing determining section 45 compares the load current computing correction value Is with pre-specified reference current values, i.e. a load current lower limit Ig1 and load current upper limit Ig2, defines an instructive delay time ts from the computed result, and generates a control signal according to instructive delay time ts. In this manner, a current value detected by current detecting section 26 is corrected, and the delay time is modified according to this corrected current value. Thus, the input power to the electric blower 11 is controlled.

It is also possible to do the following. First, in the preparation mode, load current maximum value determining section 43 stores load current maximum value Iz in non-volatile memory 32b, and load current maximum value error-computing section 46 compares this load current maximum value Iz with pre-specified load current maximum reference value Ip in the cleaning mode, obtaining a load current error Ie by the difference. Then, this load current error Ie is outputted to load current computing section 44. In this case, the load current maximum value Iz, itself, constitutes the “correction value” referred in the present invention.

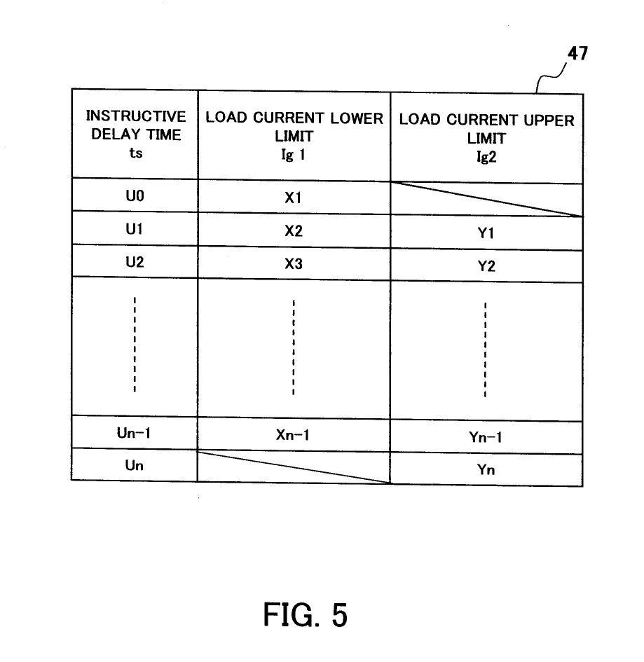

A data table 47, which is stored in memory 8 within control section 18, will now be described. FIG. 5 shows an example of data table 47, illustrating a relation among instructive delay time ts, load current lower limit Ig1, and load current upper limit Ig2.

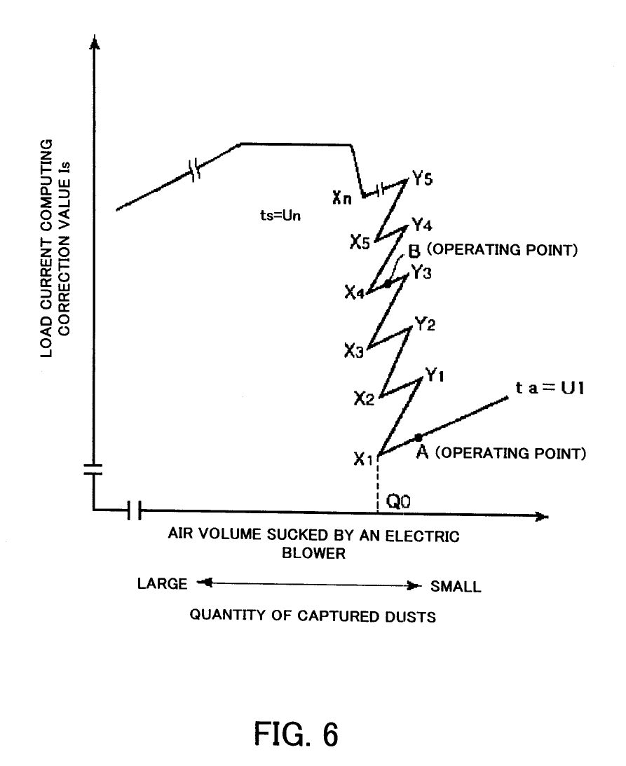

First, the individual values in the table will be explained. In this data table 47, there are provided (n+1) values U0, U1, U2, . . . , Un, each specified as instructive delay time ts and being an output timing of the control signal, where Un <, . . . , U2<U1<U0; n set values X1, X2, X3, . . . , Xn, each specified as a current lower limit Ig1 and being a comparative value corresponding to the above instructive delay time ts, where Xn>, . . . , X2>X1; and n set values Y1, Y 2, Y 3, . . . , Y n, each specified as a load current upper limit Ig2 and being also a current comparative value, where Y n>, . . . , Y 2>Y 1. The relationship among individual values of load current lower limit Ig1 and load current upper limit Ig2 in terms of magnitude comparison is illustrated in FIG. 6, that is, X1<X2<Y1<X3<Y2<X4<Y3<X5<Y4< . . . , Xn<Yn-1<Yn.

Controller 20 in FIG. 2 controls electric blower 11 by outputting a control signal as a trigger signal to three-terminal thyristor 22 from control section 18. In a state that dust-collecting bag 12 is empty, control section 18 sets instructive delay time ts to U0 so that a sucking air volume by electric blower 11 can be greater than Q0. The load current computing correction value Is in this state becomes a value, for example, as point A in FIG. 6.

As the operation of the electric vacuum cleaner progresses after it started, the airflow resistance through dust-collecting bag 12 increases by accumulation of captured dusts and the sucking airflow volume from suction inlet body 5 decreases. Along with this progressing, the load current computing correction value Is gradually decreases from point A towards set value X1 of a load current lower limit Ig1.

When the load current computing correction value Is exceeds the set value X1 of a load current lower limit Ig1, timing determining section 45 changes instructive delay time ts from U0 to shorter U1. As a result, the conducting angle of three-terminal thyristor 22 becomes wider and the air suction power of electric blower 11 increases accordingly. At this time, the load current computing correction value Is reaches Y1, and the input power of electric blower 11 is boosted.

As the dust capturing goes further, the airflow resistance through dust-collecting bag 12 continues to increase and the sucking airflow volume from suction inlet body 5 decreases. Thereby the load current computing correction value Is gradually decreases towards set value X2 of a load current lower limit Ig1.

When the load current computing correction value Is decreases exceeding X2 of a load current lower limit Ig1, timing determining section 45 changes instructive delay time ts from U1 to further shorter U2. As a result, the conducting angle of three-terminal thyristor 22 becomes even wider and the air suction power of electric blower 11 increases accordingly. Then, the load current computing correction value Is reaches Y2, and the input power of electric blower 11 becomes even greater.

In this manner, as dust capturing progresses and the load current computing correction value Is decreases exceeding set values X1, X2, X3, X4, . . . of load current lower limits Ig1, timing determining section 45 shifts instructive delay time ts to U0, U1, U2, U3, U4, . . . , respectively. After the load current computing correction value Is eventually exceeds set value Xn of load current lower limits ig1 and instructive delay time ts becomes Un, timing determining section 45 does not change instructive delay time ts even if the load current computing correction value Is continues to go lower.

If instructive delay time ts remains at Un for more than a specified period, controller 18 judges the state of dust-collecting bag 12 being in nearly full with dusts and signals to annunciating section 10. Annunciating section 10 then urges an operator of the vacuum cleaner to change the dust-collecting bag 12.

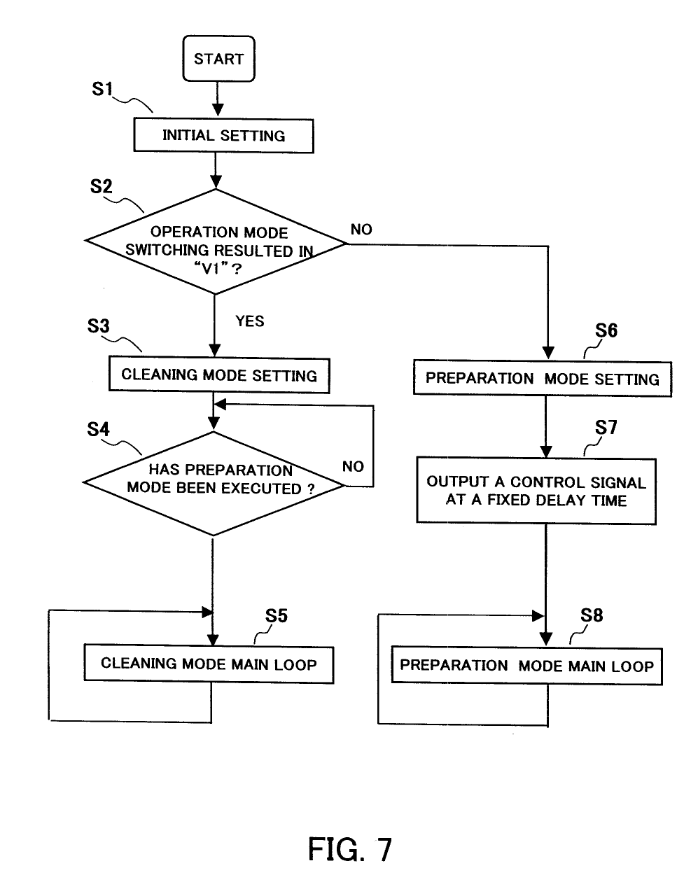

Processing in the respective control routines will now be described. Control 18 performs the operation in the main routine as illustrated in FIG. 7 in accordance with programs previously stored in memory 32. Control section 18 first carries out various initial settings in the vacuum cleaner in step S1 after power-up or resetting control section 18. In step S2, the control section 18 checks the voltage that is invoked by switching of the operation mode switch 30. If the voltage thereat is recognized to be V1, an operation mode setting section 41 sets the operation mode to “cleaning mode” in step S3. In step S4, control section 18 checks if the preparation mode has previously been made at least once. If the preparation mode has never been experienced, the step remains without further proceedings. Recognizing the experience of the preparation mode, the control section 18 generates a control signal having the initial setting of an output timing that is previously determined for starting of the operation. The step control enters the main loop in the cleaning mode in step S5, and electric blower 11 starts operation of cleaning. This loop iterates until the power is turned off.

If control section 18 judges the voltage as a result of switching of operation mode switch 30 not to be V1 in step S2, operation mode setting section 41 sets the operation mode of control section 18 to the preparation mode in step S6. In step S7, timing determining section 45 setting output timing to a predetermined value, for example, to zero (second) so that the input power to electric blower 11 becomes a maximum, the control section 18 supplies a control signal with such a time delay to the gate of three-terminal thyristor 22. In step S8, the main processing of the preparation mode is carried out and is reiterated until the power is turned off.

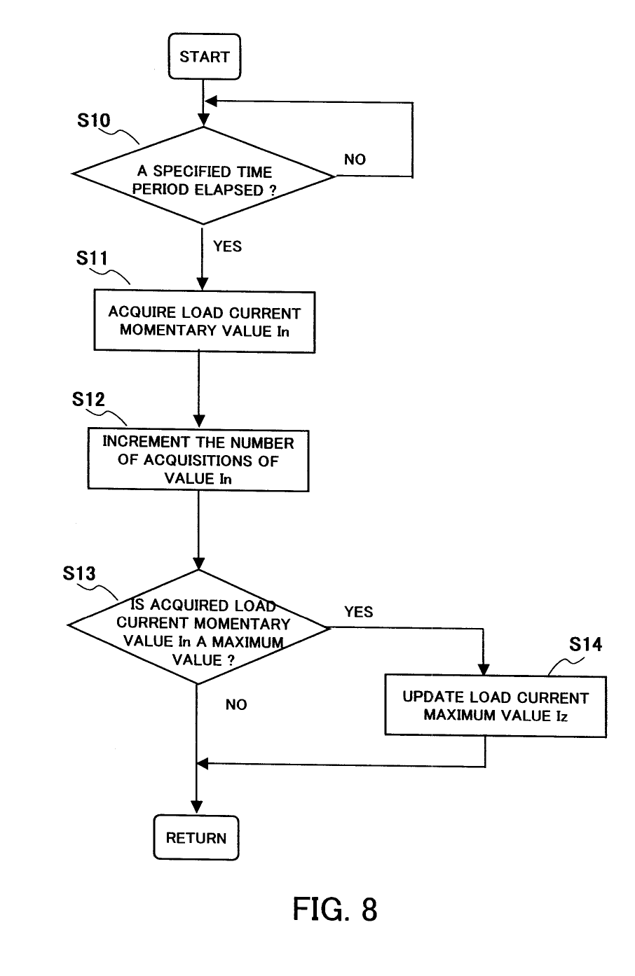

In the main loop routine in the preparation mode, control section 18 cyclically performs the load current error computation, as shown in FIG. 8, using a timer (not shown). The following describes this routine of the load current error computation.

In step S10, control section 18 checks if a specified time has elapsed after a current started to flow, i.e. after electric blower 11 started to operate, using a timer (not shown). After the elapse of the time has been confirmed, it advances to step S11. In step 511, load current momentary value acquiring section 42 cyclically acquires a load current momentary value In at a specified period from I/O port 33 with an A/D converter. Then, in step S12 the number of such acquisitions of load current momentary value In is incremented. This number of the value acqusitions will be cleared, as described later, at a zero-crossover point of the alternate-current power source voltage that is detected by zero-cross detection section 28.

The acquisition period for acquiring the load current momentary value In is previously set. In this embodiment, this acquisition period is set to 0.2 m sec for the alternate-current power source at 50 Hz. Accordingly, the acquisition of the load current momentary value In is to be made 50 times in a half cycle of the alternate-current power source voltage. This period becomes a period of computing a correction value to be stored in a non-volatile memory 32b.

Subsequently, in step S13 load current maximum value determining section 43 judges if each acquired load current momentary value In is a maximum at every acquisition of the load current momentary value In, timing of the acquisition being set relative to the zero-crossover point. If an acquired load current momentary value In is found to be a maximum value, that load current momentary value is stored in the memory as a load current maximum value Iz in step S14. Then, the same routine is reiterated in a specified period in step S10 through S14, and the load current maximum value Iz is determined from 50 samples of the load current momentary values In in a half cycle of the alternate-current power source voltage. Then, it is returns to the main loop of preparation mode from this processing. In the routine described in the above, a maximum value among load current momentary values In sampled predetermined times is determined to be a load current maximum value Iz. However, this load current maxim value Iz may be determined, for example, such that after several averages in load current momentary values In are calculated and a maxim value is chosen from those averages as a load current maximum value.

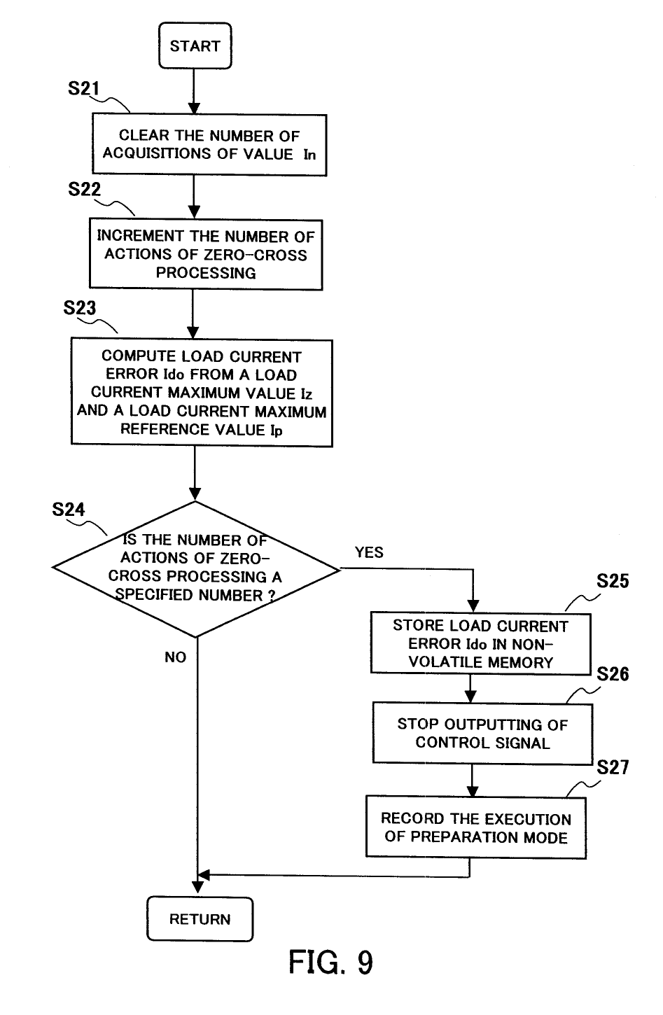

In this processing of the preparatory mode, control section 18 carries out “preparation mode zero-cross processing,” as illustrated in FIG. 9, it every detection of a zero-crossover point in the alternate-current power source voltage.

In this processing, when zero-cross detecting section 28 detects a zero-crossover point, the number of acquisitions of a load current momentary value In counted in the routine of load current error computation, illustrated in FIG. 8, is cleared in step S21. Subsequently, the control section 18 increments the number of the zero-cross processing in step S22. In step S23, the acquired load current maximum value Iz is compared to load current maximum reference value Ip that is previously stored in memory 32 and the error Id0 is computed. In this case, the difference between Iz and Ip is taken for the error Id0 as an example. Then, instep S24, control section 18 checks if predetermined times of the zero-cross processing have been operated. If the specified number of the operation has not been reached yet, the step returns the preparation mode main routine and steps S21 through S23 are reiterated until the number is reached. Upon completion of the processing of the predetermined times, the control section 18 computes, in step S25, a load current correction value Id as a correction value based on a number of errors Id0 that have been computed in the previously repeated processing, for example, by averaging them, and stores it in non-volatile 32b. In step S26, timing determining section 45 stops outputting the control signal to three-terminal thyristor 22. At the end, in step S 27 control section 18 records the fact, as information, that this preparation mode processing has been executed in non-volatile memory 32b.

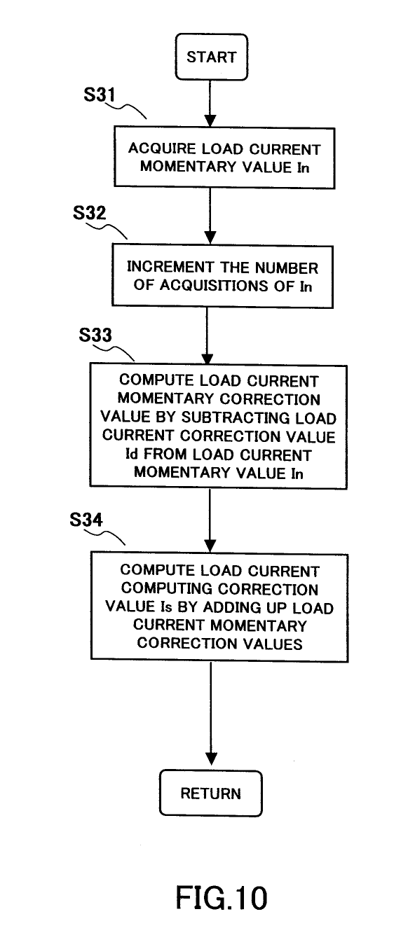

Now, the case where the operation mode of the control section 18 is set to the cleaning mode will be described. In this cleaning mode, control section 18 periodically performs processing of calculating the load current computing correction value Is, as shown in FIG. 10, using a timer (not shown) or the like.

First, in step S31 a load current momentary value acquiring section 51 acquires a load current momentary value In from I/C port 33 equipped with an A/D converter. In next step S32, control section 18 increments the number of acquisitions of the load current momentary value In. In this embodiment, a period of acquiring load current momentary value In is set to 0.2 m sec as set in the preparation mode.

Subsequently, in step S33, load current computing section 53 computes a load current momentary correction value, for example, by subtracting the load current correction value Id stored in the preparation mode from load current momentary value In. Then, in step S34, the load current computing correction value Is is obtained, for example, by adding this load current momentary correction value 100 times in one period of the alternate-current power source voltage. The period of the alternate-current power source can be known by the zero-cross signal detected by zero-cross detecting section 28. Thereafter, the step returns to the cleaning mode main loop and the processing of steps S31 through S34 are reiterated in a predetermined period.

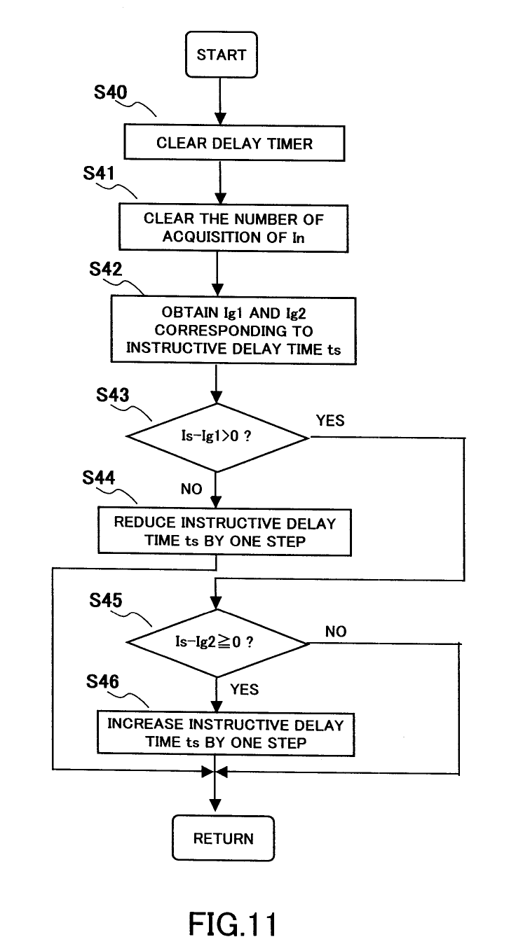

In the cleaning mode main loop, control section 18 carries out the zero cross timing processing, as illustrated in FIG. 11, at every zero-cross timing point in the alternate-current power source.

First, in step S40, control section 18 clears a delay timer that counts a delay time from a zero-crossover point to the output timing of the control signal. Subsequently, in step S41, control section 18 also clears the number of the acquisitions of a load current momentary value In that has been counted in the processing for computing the load current computing correction value Is. In step S42, timing determining section 45 acquires an appropriate load current lower limit Ig1 and the load current upper limit ig2 corresponding to instructive delay time ts at the time. In step S43, a load current computing correction value Is is compared to the acquired load current lower limit Ig1 stored in the memory. If Is−Ig1>0, the load current computing correction value Is is further compared to load current upper limit Ig2 in step. If Is−Ig2<0, control section 18 takes the state of the electric blower as being operating within the range of operational input power setting according to instructive delay time ts at the time.

Meanwhile, in step S43, if Is−Ig1<0, control section 18 takes a current input power level of the electric blower 11 as being lower than the previously set range values; in step S44, the control section boosts the input power to the electric blower 11 by shortening instructive delay time ts by one step, e.g. from U0 to U1, according to the values in the table in FIG. 5.

If Is−Ig2≧0 in step S45, control section 18 takes, a current input power of the electric blower 11 as being greater than the previously set range values; in step S46, control section 18 reduces the input power to the electric blower 11 by extending instructive delay time ts by one step, e.g. from U3 to U2. Thereafter, the step returns to cleaning mode main loop, and steps S40 through S46 are reiterated every time zero-cross detecting section 28 detects a zero-crossover point.

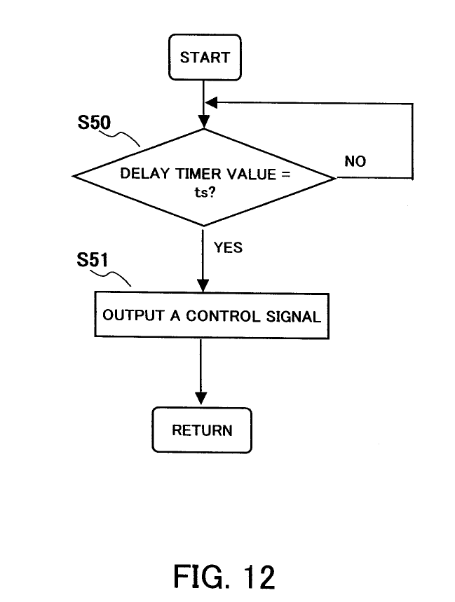

Timing determining section 45 starts to measure a delay time relative to a zero-crossover point using a delay timer (not shown), and periodically performs processing, as illustrated in FIG. 12, for outputting the control signal.

That is, in step S50 control section 18 confirms that the delay time relative to the zero-crossover point conforms to instructive delay time ts, and if so, it controls so that a control signal reflecting this delay time is dispatched from I/O port 33 to three terminal thyristor 22 in step S51.

In this manner, instructive delay time ts is determined by the result of comparison of load current computing correction value Is with load current lower limit Ig1 and load current upper limit Ig2. Load current lower limit Ig1 and load current upper limit Ig2 are current reference values that have been previously determined, and load current computing correction value Is is computed from load current momentary value In and load current correction value Id (as a correction value). Therefore, in the cleaning mode, instructive delay time ts is determined according to the load current momentary value, the current reference value, and the correction value. That is, control section 18 compares the computed load current computing correction value with previously set load current lower limit Ig1 and load current upper limit Ig2, and control is made by adjusting instructive delay time ts based on the result of this comparison so that the input power to the electric blower 11 is held within a preset range. In this way, a detected current varies according to a sucking air volume by electric blower 11 and the load current computing correction value Is changes accordingly. Thus, the input power to the electric blower 11 is controlled so as to fall within a suitable range that is previously defined by adjusting instructive delay time ts according to the amount of captured dusts within dust-collecting bag 12. As a result, the suction power of the electric vacuum cleaner can be held on longer.

As has been described in the above, because the electric vacuum cleaner according to this embodiment is configured so as to correct the current detection error resulted due to a variation of electric components used in current detecting section 26 by detecting the periodic waveform of a load current that is associated with the alternate-current power source, the ripple component resulted from the commutator motor can also be caught in the current detection, and hence, the above current detection error can be accurately corrected. As a result, a variation of the input power among individual electric blowers is suppressed, improving the accuracy of controlling the input power of an electric vacuum cleaner, and hence, the performance of capturing dusts has become stabilized. Furthermore, since the zero cross detection circuit (used in this embodiment), in which the error correction is carried out based on the periodic load current relative to the alternate-current power source, is essentially required in order to generate a control signal to three-terminal thyristor 22, i.e. as for so-called “phase control for such a device,” the structure of this circuit is not one to be newly added. Accordingly. This circuit can be realized without complicating it, nor increasing the parts cost. Furthermore, since the error correction is made by taking a load current maximum value in the detected load current momentary values, which largely reflects the variation among electrical components in current detecting section 26, the accuracy of the error correction can be more effectively improved.

### Second Embodiment

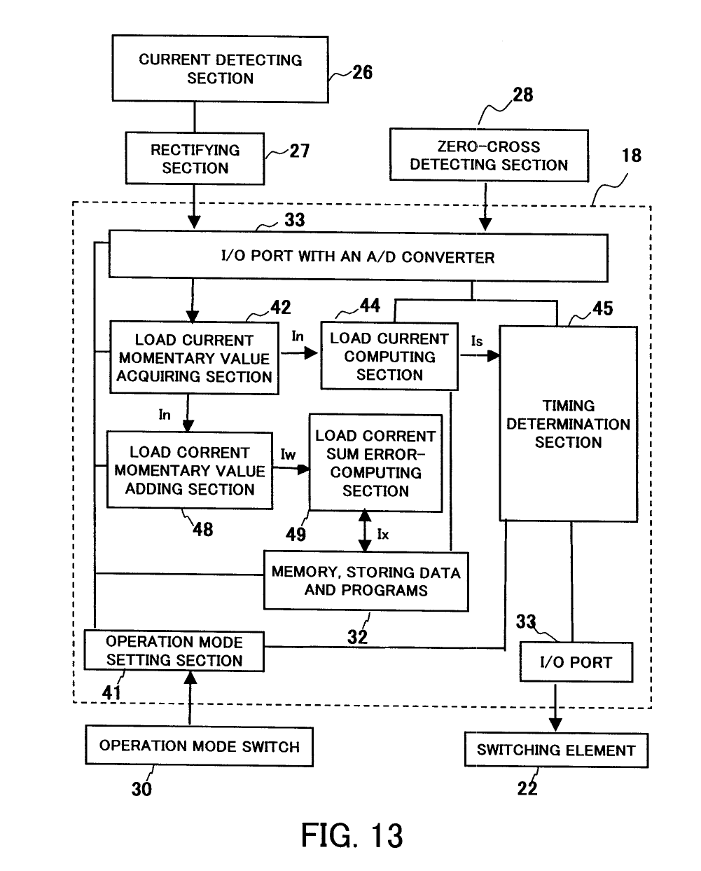

The second embodiment according to the present invention will now be described in conjunction with FIG. 13. In the electric vacuum cleaner according to the first embodiment described above, the correction value to be stored in the memory is taken from a load current maximum value, which is a maximum value in load current momentary values acquired in the preparation mode. In the second embodiment, a correction value to be stored in the memory is taken from a sum of several load current momentary values in the preparation mode.

The structure of controller 20 in this embodiment will first be explained in reference to FIG. 13. Parts common to the structure shown in FIG. 4 bear identical reference numerals, and description for them will here be omitted. The electric vacuum cleaner according to the second embodiment differs from one illustrated in FIG. 4 in respect that a load current momentary value adding section 48 and a load current sum error-computing section 49 are additionally provided. In the preparation mode in this embodiment, load current momentary value acquiring section 42 acquires a load current momentary value In from current detecting section 26 in predetermined acquiring intervals, and that load current momentary value In is then outputted to load current momentary value adding section 48. The load current momentary value adding section 48 adds up load current momentary values (I1, I2, . . . , In) sampled a predetermined times starting from the zero crossover point, and the resulted load current total value Iw is sent to a load current sum error-computing section 49. The load current sum error-computing section 49 then compares the calculated load current total value Iw with a preset load current sum reference value Iy, and acquires a load current sum correction value Ix from the comparison result, storing it at non-volatile memory 32b. The load current sum correction value Ix can be determined by the difference itself between load current total value Iw and load current sum reference value Iy, or by a value obtained from a separate data table or a formula.

In the cleaning mode, load current computing section 44 computes the load current computing value IsO by adding up load current momentary value In a predetermined times, then obtains a load current computing correction value Is from this load current computing value IsO and the load current sum correction value Ix, and the resulted load current computing correction value Is is sent to timing determining section 45. The load current computing correction value Is can be obtained, for example, by adding or subtracting a load current correction value Id to/from the load current computing value IsO. The timing determining section 45 compares the load current computing correction value Is with a preset load current lower limit Ig1 and a load current upper limit Ig2, and obtains an instructive delay time ts from the result of the comparison, and generates a control signal based on this instructive value ts.

In this way, in this invention it is also possible to add up load current momentary values In sampled specified times in the preparation mode, and then takes a correction value to be stored in non-volatile memory 32b from the sum of the addition. In this case, since the correction value is computed by integrating load current momentary values In, affection by a noise, if presented, can be suppressed. Thereby reliability of the error correction is enhanced.

### Third Embodiment

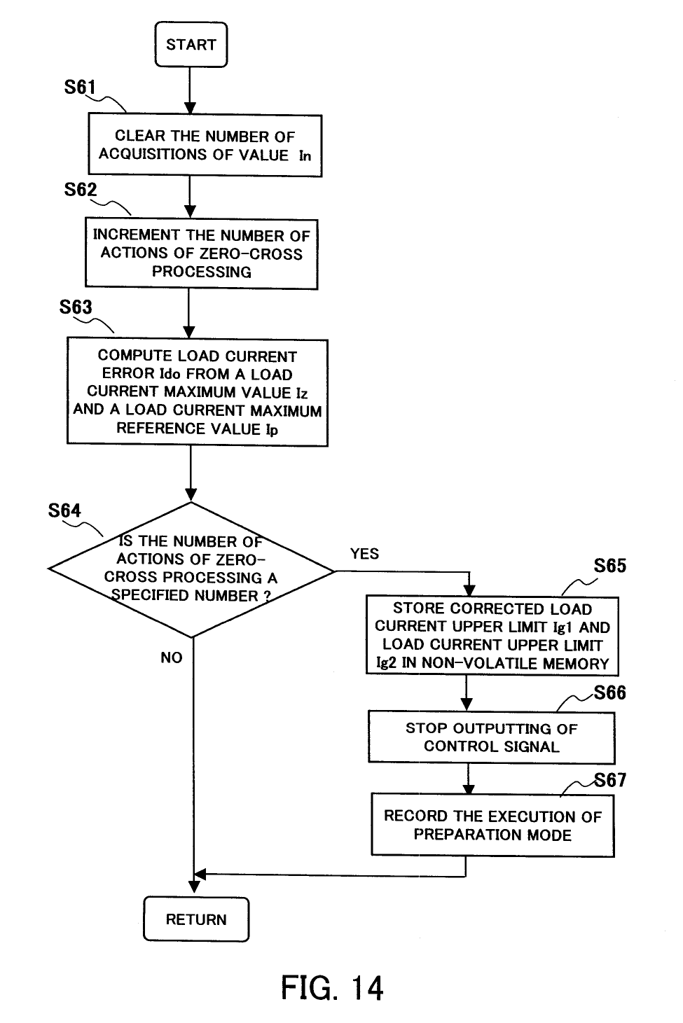

The third embodiment according to the present invention will next be described in conjunction with FIG. 14. The structure of controller 20 in this embodiment is identical to one in the first embodiment shown in FIG. 4. However, the processing carried out within the controller 20 differs from the former. That is, in this third embodiment, which will be described below, a current reference value itself previously stored in the memory is corrected, whereas in the first embodiment the detected current sampled in the cleaning mode is corrected.

In this embodiment, the same operation as in the first embodiment illustrated in FIG. 8 is performed. However, in the preparation mode of this embodiment, the operation as illustrated in FIG. 14 is carried out at every incident of detecting a zero-crossover point in the alternate-current source voltage.

Control section 18 first clears, in step S61, the number of the acquisitions of the load current momentary value In that is incremented in each of the routine of computing a load current error illustrated in FIG. 8. Then, in step S62, the number of the zero-cross processing is incremented. In step S63, a difference Ido is computed by comparing load current maximum value Iz with the load current maximum reference value Ip stored in memory 32. Then, in step S64, control section 18 checks if the counted number of the zero-cross processing has reached the preset number. If the number is not reached, the step returns to the preparation mode main loop and the processing of step S61 through S63 is continuously performed until the specified number is reached. If, in step S64, it is confirmed that the specified number has been reached, then, control section 18 corrects, in step S65, load current lower limit Ig1 and load current upper limit Ig2, as indicated in FIG. 5, which become current reference values, and stores these revised values of load current lower limit Ig1 and load current upper limit Ig2 in non-volatile memory 32b. In step S36, timing determining section 45 ceases outputting of the control signal to three-terminal thyristor 22. At last, control section 18 records, in step S67, the execution of the processing in the preparation mode as information in non-volatile memory 32b.

Control section 18 does no corrective actions in the cleaning mode, while timing determining section 45 determines the output timing by comparing the detected current with the corrected current reference value that has been corrected in the preparation mode.

Incidentally, the cleaning mode described above involves various controls relative to operations of the vacuum cleaner other than the control of input power to electric blower 11, such as control for annunciating a warning when the dust-collecting bag is filled up with dusts. Executing such controls heavily burdens the microprocessor 31. In this embodiment, since corrections of initial set values are handled in the preparation mode and such corrections are not operated in the cleaning mode at all, a load of microprocessor 31 for processing in the cleaning mode can be alleviated. As a result, the electric vacuum cleaner according to this embodiment has an advantage in which the speed of processing various controls in the cleaning mode is not impaired. Although in the third embodiment load current lower limit Ig1 and load current upper limit Ig2 are adjusted based on the load current maximum value in the preparation mode, the load current limits Ig1 and Ig2 may be adjusted based on a sum of load current momentary values as has been made in the second embodiment.

Also, in the first and third embodiments, control section 18 corrects the detected current or the preset current value by using load current maximum value Iz, which has been acquired selecting from multiple load current momentary values In. If, when using such a load current maximum value Iz, load current momentary values In within a period between a zero-crossover point and the control signal generating point, or periods indicated as “non-usable range” in FIG. 3(e2) are not used for the purpose of the value correction, the reliability of the corrective performance can be (even more) enhanced. This is because during these time periods none or very small amount of current flows and there is no possibility that the load current maximum value Iz is presented there. If a fair amount of current emerges therein, it can be taken as a noise. Excluding such time periods as the usable area for correcting the load current momentary value In, as described above, encompasses not only the case where load current momentary values In within these time period have been acquired but not used for the purpose of the value correction, but also the case that the performance of acquiring the load current momentary value In as such is not implemented.

Also, in the second embodiment, control section 18 adds up multiple load current momentary values In and the correction value is obtained using the sum of this addition. If, when such a sum is used, load current momentary values In in the above non-usable time periods which have been acquired are excluded from the use for the computation, a fair degree of accuracy of the detection can be maintained and processing load of microprocessor 31 can be alleviated. This is because load current momentary values In within the non-usable time periods are small and hence affection to the correction values by omission of these current momentary values In is very little, and reduction in a number of load current momentary values In to be processed can also reduce the processing load of microprocessor 31.

Furthermore, by providing the process steps of S27 as in FIG. 9 and S67 as in FIG. 14, control section 18 is inhibited from operating in normal cleaning mode unless the preparation mode has previously been experienced at least once. Thereby an error of missing the correction process in the mass production can be avoided.

Still furthermore, in the respective embodiments as described above, timing determining section 45 has acquired the respective load current set value Ig1, according to instructive delay time ts, from n set values X1, X2, X3, X4, . . . of load current lower limits Ig1 as indicated in the data table in FIG. 5. However, this invention is not restricted to the usage of such tabled values. If a set value of load current lower limit Ig1 located in the first line is assumed to be X1, “n”th set value Xn may be given by an arithmetic formula, Xn=Z1+A·(n·1)·ts, or the like. Timing determining section 45 then generates triggering signals based on the values obtained in this manner.

An interval between instructive delay times ts, Un−Un_{·1}=ΔUn, an interval between the load current lower limits Ig1, Xn−Xn_{·1}=ΔXn, and an interval between the load current upper limits Ig2, Yn−Yn_{·1}=ΔYn need not be uniformly provided. Such intervals may be determined depending on applications of an electric vacuum cleaner or characteristics of electric blower 11.

The operations performed by the respective sections constituting control section 18, comprising operation mode setting section 41, load current at momentary value acquiring section 42, load current maximum value determining section 43, load current computing section 44, timing determining section 45, and load current maximum value error computing section 46, need not be necessarily implemented by programs stored in the memory 32, but such a software-oriented structure may be substituted by a hardware-implementing structure.

What is claimed is:

1. An electric vacuum cleaner comprising:
an electric blower having a commutator motor connected to an alternate-current power source through a switching element controlled by a control signal and a fan rotated by the commutator motor;
a zero-cross detecting section for detecting a zero crossover point of an alternate-current voltage applied to the commutator motor;
a current detecting section for detecting a load current flowing in the commutator motor;
a control section for controlling a timing of outputting the control signal relative to the zero crossover point detected by the zero-cross detecting section based on a value of the load current detected by the current detecting section and a preset current reference value;
a current detecting circuit for generating a signal having a periodic waveform using the load current detected by said current detecting section and outputting the periodic signal to said control section, the periodic signal generated by said current detecting circuit relating to the alternate-current voltage,
wherein said control section comprising:
operation mode setting means for setting an operation mode of the vacuum cleaner to one of a preparation mode in which the output timing of the control signal is fixed and a cleaning mode in which the output timing of the control signal is set variable;
load current momentary value acquiring means for acquiring load current momentary values by sampling the periodic signal from said current detecting circuit in a specified sampling interval, the sampling commencing based on the zero crossover point detected by the zero-cross detecting section;
storing means for storing a correction value that is determined based on the load current momentary values acquired by said load current momentary value acquiring means in the preparation mode;
timing determining means for determining the timing of outputting the control signal to the switching element in the cleaning mode based on the load current momentary values acquired by said load current momentary value acquiring means, the current reference value, and the correction value.

2. An electric vacuum cleaner according to claim 1, wherein said storing means stores, in the preparation mode, a correction value which is determined based on a maximum value within the load current momentary values acquired by said load current momentary value acquiring means.

3. An electric vacuum cleaner according to claim 1, wherein said storing means stores, in the preparation mode, a correction value which is determined based on a sum of a plurality of load current momentary values acquired by said load current momentary value acquiring means.

4. An electric vacuum cleaner according to claim 1, wherein said storing section stores, in the preparation mode, a correction value determined based on the load current momentary values which reside out of a prespecified range relative to the zero crossover point detected by said zero-cross detecting section.

5. An electric vacuum cleaner according to claim 1, wherein said storing section stores, in the preparation mode, a correction value determined based on the load current momentary values which reside out of a prespecified range relative to the timing of outputting the control signal.

6. An electric vacuum cleaner according to claim 1, wherein said control section operates in the cleaning mode only after the preparation mode has been activated at least once.

7. An electric vacuum cleaner according to claim 1, wherein said control section controls said electric blower in the preparation mode so as to operate consistently at a maximum input power.

8. An electric vacuum cleaner comprising:
an electric blower having a commutator motor connected to an alternate-current power source through a switching element controlled by a control signal and a fan rotated by the commutator motor;
a zero-cross detecting section for detecting a zero crossover point of an alternate-current voltage applied to the commutator motor;
a current detecting section for detecting a load current flowing in the commutator motor;
a control section for controlling a timing of outputting the control signal relative to the zero crossover point detected by the zero-cross detecting section based on a value of the load current detected by the current detecting section and a preset current reference value;
a current detecting circuit for generating a signal having a periodic waveform using the load current detected by said current detecting section and outputting the periodic signal to the control section, the periodic signal generated by said current detecting circuit relating to the alternate-current voltage,
wherein said control section comprising:
operation mode setting means for setting an operation mode of the vacuum cleaner to one of a preparation mode in which the output timing of the control signal is fixed and a cleaning mode in which the output timing of the control signal is set variable;
load current momentary value acquiring means for acquiring load current momentary values by sampling the output from said current detecting circuit in a specified sampling interval, the sampling commencing based on the zero crossover point detected by the zero-cross detecting section;
correcting means for correcting the current reference value based on the load current momentary values acquired by said load current momentary value acquiring means in the preparation mode;
storing means for storing the corrected current reference value that has been corrected by said correcting means;
timing determining means for determining the timing of outputting the control signal to the switching element in the cleaning mode based on the load current momentary values acquired by said load current momentary value acquiring means, the current reference value, and the correction value.

9. An electric vacuum cleaner according to claim 8, wherein said correcting means corrects, in the preparation mode, the current reference value based on a maximum value within the load current momentary values acquired by said load current momentary value acquiring means.

10. An electric vacuum cleaner according to claim 8, wherein said correcting means corrects, in the preparation mode, the current, reference value based on a sum of a plurality of load current momentary values acquired by said load current momentary value acquiring means.

11. An electric vacuum cleaner according to claim 8, wherein said correcting means corrects, in the preparation mode, the current reference value based on the load current momentary values which reside out of a prespecified range relative to the zero crossover point detected by said zero-cross detecting section.

12. An electric vacuum cleaner according to claim 8, wherein said correcting means corrects, in the preparation mode, the current reference value based on the load current momentary values which reside out of a prespecified range relative to the timing of outputting the control signal.

13. An electric vacuum cleaner according to claim 8, wherein said control section operates in the cleaning mode only after the preparation mode has been activated at least once.

14. An electric vacuum cleaner according to claim 8, wherein said control section controls said electric blower in the preparation mode so as to operate consistently at a maximum input power.
